(19) United States
(12) Patent Application Publication
(10) Pub. No.: US 2025/0243926 A1
(43) Pub. Date: Jul. 31, 2025

(54) CONTINUOUSLY VARIABLE TRANSMISSIONS, SYNCHRONOUS SHIFTING, TWIN COUNTERSHAFTS AND METHODS FOR CONTROL OF SAME

(71) Applicant: enviolo B.V., Amsterdam (NL)

(72) Inventor: Brian SCHOOLCRAFT, Cedar Park, TX (US)

(21) Appl. No.: 19/001,240

(22) Filed: Dec. 24, 2024

Related U.S. Application Data
(63) Continuation of application No. 18/133,409, filed on Apr. 11, 2023, now Pat. No. 12,173,778.
Application No. 18/133,409 is a continuation of application No. 17/537,871, filed on Nov. 30, 2021, now Pat. No. 11,624,432.
Application No. 17/537,871 is a division of application No. 16/674,785, filed on Nov. 5, 2019, now Pat. No. 11,215,268.
(60) Provisional application No. 62/756,478, filed on Nov. 6, 2018.

(51) Int. Cl. F16H 37/02; B60K 17/08; B60W 10/04; B60W 10/06; B60W 10/101; B60W 10/108; B60W 10/11; B60W 10/115; B60W 30/182; B60W 30/188; B60W 30/19; F16H 3/44; F16H 37/06; F16H 37/08; F16H 59/14; F16H 59/46; F16H 61/04

(52) U.S. Cl. CPC F16H 37/022; B60K 17/08; B60W 10/04; B60W 10/101; B60W 10/11; B60W 30/182; B60W 30/1882; B60W 30/19; F16H 3/44; F16H 37/065; F16H 37/086; F16H 61/0437; B60W 10/06; B60W 10/108; B60W 10/115; B60W 30/188; B60W 2510/0208; B60W 2510/0241; B60W 2510/1025; B60W 2710/0677; B60W 2710/1005; F16H 2003/442; F16H 2037/028; F16H 59/14; F16H 2059/465; F16H 2200/2005; F16H 2200/2007; F16H 2200/201; F16H 2200/2033; F16H 2200/2064; F16H 2200/2082; F16H 2306/40; F16H 2702/02

(57) ABSTRACT

Systems and methods for controlling transmissions having CVTs are disclosed with multiple modes and gearing arrangements for range enhancements, where embodiments include synchronous shifting to allow the transmission to achieve a continuous range of transmission ratios, while minimizing “empty” cycling of the CVT during mode shifts. Embodiments provide for wide ratio range and performance and efficiency flexibility, while maximizing CVT usage through synchronous shifting.

### CROSS-REFERENCE TO RELATED APPLICATIONS

This application is a continuation of U.S. patent application Ser. No. 18/133,409, filed on Apr. 11, 2023, entitled “CONTINUOUSLY VARIABLE TRANSMISSIONS, SYNCHRONOUS SHIFTING, TWIN COUNTERSHAFTS AND METHODS FOR CONTROL OF SAME,” which is a continuation of U.S. patent application Ser. No. 17/537,871, filed on Nov. 30, 2021, entitled “CONTINUOUSLY VARIABLE TRANSMISSIONS, SYNCHRONOUS SHIFTING, TWIN COUNTERSHAFTS AND METHODS FOR CONTROL OF SAME,” now U.S. Pat. No. 11,624,432, which is a divisional of U.S. Nonprovisional patent application Ser. No. 16/674,785, filed on Nov. 5, 2019, entitled “CONTINUOUSLY VARIABLE TRANSMISSIONS, SYNCHRONOUS SHIFTING, TWIN COUNTERSHAFTS AND METHODS FOR CONTROL OF SAME,” now U.S. Pat. No. 11,215,268, which claims the benefit of U.S. Provisional Patent Application No. 62/756,478, filed on Nov. 6, 2018, entitled “CONTINUOUSLY VARIABLE TRANSMISSIONS AND SYNCHRONOUS SHIFT TWIN COUNTERSHAFTS AND METHODS FOR CONTROL OF SAME.” The contents of the above-referenced applications are hereby incorporated by reference in their entirety.

### BACKGROUND

### Field of the Disclosure

The present disclosure relates generally to mechanical power transmission, and more particularly to continuously variable transmissions, and for methods of synchronous shifting.

### Description of the Related Art

Power transmissions of any type can also be grouped generally into three categories: manual, synchronous and non-synchronous according to how they shift. In manual transmissions, a user is responsible for depressing a clutch to release a gear, shifting the transmission and releasing the clutch to apply the new gear ratio. In non-synchronous shifting in an automatic transmission, when the transmission shifts gears, only one clutch or band is applied or released. Synchronous shifting in transmission generally refers to the coordinated and usually simultaneous application and release of two or more clutches, bands or other control mechanisms.

### SUMMARY OF THE DISCLOSURE

In one broad respect, embodiments disclosed herein are directed to a drivetrain capable of synchronous shifting with a continuously variable transmission. Certain embodiments relate to a transmission having a planetary gearset for receiving rotary power from an input source, a variator, a first countershaft, a second countershaft, an output shaft receiving power from each of the first gear and the second gear, and a control system having a first clutch, a second clutch; and a controller configured to adjust the speed ratio of the variator and selectively engage the first gear or the second gear, wherein in a first mode, the control system is configured to engage the first gear on the first countershaft and adjust the variator from the first maximum speed ratio to the second maximum speed ratio to increase the transmission ratio from a first transmission ratio to a second transmission ratio, wherein in a second mode, the control system is configured to engage the second gear on the second countershaft and adjust the variator from the second maximum speed ratio to the first maximum speed ratio to increase the transmission ratio from the second transmission ratio to a third transmission ratio, and wherein changing from the first mode to the second mode comprises disengaging the first clutch from the first gear and engaging the second clutch to the second gear.

In another embodiment, in the first mode, power is transmitted through the planetary gearset and the variator according to a first power path, and in the second mode, power is transmitted through the planetary gearset and the variator according to a second power path, and changing from the first mode to the second mode includes changing a configuration of the planetary gearset.

In another embodiment, the planetary gearset is a double planetary gearset, in the first mode, power is transmitted from a first set of planetary gears to the variator, in the second mode, power is transmitted from a second set of planetary gears to the variator, and changing from the first mode to the second mode includes changing from the first set of planetary gears to the second set of planetary gears. In some embodiments, changing from the first mode to the second mode includes changing a configuration of the variator. In certain embodiments, the variator comprises a ball planetary continuously variable transmission having a plurality of traction planets, and the control system is configured to change a tilt angle of the plurality of traction planets to adjust the speed ratio of the variator. In certain embodiments, the variator has a first traction ring on a first side of the plurality of traction planets, a second traction ring on a second side of the plurality of traction planets, and a sun located radially inward of the plurality of traction planets, and in a first mode, power is transferred from the first traction ring through the plurality of traction planets to one of the second traction ring or the traction sun, and in a second mode, power is transferred from the second traction ring through the plurality of traction planets to the first traction ring.

In another embodiment, the transmission also includes a third gear associated with the first countershaft, a third clutch corresponding to the third gear, a fourth gear associated with the second countershaft, and a fourth clutch corresponding to the fourth gear, and in a third mode, the control system engages the third gear on the first countershaft and adjusts the variator from the first maximum speed ratio to the second maximum speed ratio to increase the transmission ratio from the third transmission ratio to a fourth transmission ratio, and in a fourth mode, the control system engages the fourth gear on the second countershaft and adjusts the variator from the second maximum speed ratio to the first maximum speed ratio to increase the transmission ratio from the fourth transmission ratio to a fifth transmission ratio, and changing from the second mode to the third mode includes disengaging the second clutch from the second gear and engaging the third clutch to the third gear, and changing from the third mode to the fourth mode includes disengaging the third clutch from the third gear and engaging the fourth clutch to the fourth gear. In some embodiments, the transmission includes an infinitely variable transmission (IVT) clutch, an IVT gear coupled to the first countershaft, an output planetary gearset coupled to the output shaft, and a forward clutch coupled to the output planetary gearset, and the control system can engage the forward clutch for the first mode or the second mode, and in an IVT mode, the control system engages the IVT clutch to the IVT gear and engages the fourth clutch to the fourth gear, and the control system adjusts the speed ratio of the variator to one of a positive transmission ratio, a negative transmission ratio, and a powered zero transmission ratio.

In certain embodiments, the transmission also includes an infinitely variable transmission (IVT) clutch, an IVT gear coupled to the second countershaft, an output planetary gearset coupled to the output shaft, and a forward clutch coupled to the output planetary gearset, and the control system engages the forward clutch for the first mode or the second mode, and in an IVT mode, the control system engages the IVT clutch to the IVT gear and engages the first clutch to the first gear, and the control system adjusts the speed ratio of the variator to one of a positive transmission ratio, a negative transmission ratio, and a powered zero transmission ratio, and the control system is disengages the IVT clutch from the IVT gear and engages the forward clutch to change from the IVT mode to the first mode.

In some embodiments of the transmission, the input source comprises a prime mover, and the control system comprises a prime mover controller and a plurality of sensors associated with the prime mover and the transmission, and the control system receives an input signal associated with a target output power, and adjusts one or more parameters of the prime mover and the transmission to achieve the target output power. While in certain embodiments of the transmission, the control system operates according to one of a plurality of control algorithms, and in an efficiency control algorithm, the prime mover and the transmission are controlled to operate the prime mover based on an efficiency map, and in a power control algorithm, the prime mover and the transmission are controlled to operate the prime mover based on a power map. In some cases, operating the control system in the efficiency control algorithm includes maintaining the prime mover within an operating range for input power efficiency. In certain cases, operating the control system in the power control algorithm includes adjusting the prime mover over a range of power inputs for the target output power.

The systems and methods herein described have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of the system and methods provide several advantages over traditional systems and methods.

### BRIEF DESCRIPTION OF THE DRAWINGS

FIG. 1A depicts a schematic diagram, illustrating a layout of one embodiment of a drivetrain capable of synchronous shifting between modes;

FIG. 1B depicts a table of clutch states for configuring the embodiment depicted in FIG. 1A;

FIG. 1C depicts a graph of CVP ratio versus transmission ratio for the embodiment depicted in FIG. 1A, illustrating synchronous shifting at each shift;

FIG. 1D depicts a schematic diagram, illustrating an alternative layout of one embodiment of a drivetrain capable of synchronous shifting between modes;

FIG. 1E depicts a table of clutch states for configuring the embodiment depicted in FIG. 1D;

FIG. 1F depicts a graph of CVP ratio versus transmission ratio for the embodiment depicted in FIG. 1D, illustrating synchronous shifting at each shift;

FIG. 2A depicts a schematic diagram, illustrating a layout of one embodiment of a drivetrain capable of synchronous shifting;

FIG. 2B depicts a table of clutch states for configuring the embodiment depicted in FIG. 2A;

FIG. 2C depicts a graph of CVP ratio versus transmission ratio for the embodiment depicted in FIG. 2A, illustrating synchronous shifting at each shift;

FIG. 3A depicts a schematic diagram, illustrating a layout of another embodiment of a drivetrain capable of synchronous shifting;

FIG. 3B depicts a table of clutch states for configuring the embodiment depicted in FIG. 3A;

FIG. 3C depicts a graph of CVP ratio versus transmission ratio for the embodiment depicted in FIG. 3A, illustrating synchronous shifting; and

FIGS. 4A-4B, 5A-5B, 6A-6B, 7A-7B, 8A-8B, 9A-9B, 10A-10B, 11A-11B, 11C-11D, 12A-12B, 13A-13B, 14A-14B, 15A-15B, 15C-15D, 16, and 17 depict schematic and block diagrams of embodiments of a drivetrain configured for multiple forward modes and a reverse mode.

### DETAILED DESCRIPTION

Certain embodiments will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments. Furthermore, embodiments may include several novel features, no single one of which is solely responsible for its desirable attributes or which is essential to practicing the systems and methods herein described. The CVT/IVT embodiments described herein are generally related to types of CVT/IVT transmissions and variators known as continuously variable planetary drives or CVP disclosed in U.S. Pat. Nos. 6,241,636, 6,419,608, 6,689,012, and 7,011,600. The entire disclosure of each of these patents is hereby incorporated herein by reference. While CVPs are a type of CVT/IVT, the terms may be used interchangeably throughout this application, unless otherwise specifically stated in this detailed description.

For description purposes, the term “radial” is used herein to indicate a direction or position that is perpendicular relative to a longitudinal axis of a transmission or variator. The term “axial” as used herein refers to a direction or position along an axis that is parallel to a main or longitudinal axis of a transmission or variator. Certain operations described herein are intended to be executed by one or more processors or microprocessors capable of executing instructions of sufficient speed and complexity that they cannot be performed in the mind of a person. Many operations described herein are understood as requiring and providing speed, accuracy and complexity management that are not obtainable by human mental steps, in addition to the inherently digital nature of such operations (e.g., a human mind cannot interface directly with I/O module, RAM, ROM, other digital storage to search a result or generate further instructions). While this is readily understood by persons of ordinary skill in the art, others who may have need to review the disclosure of this application may from time to time need to be instructed, informed, or reminded of such facts.

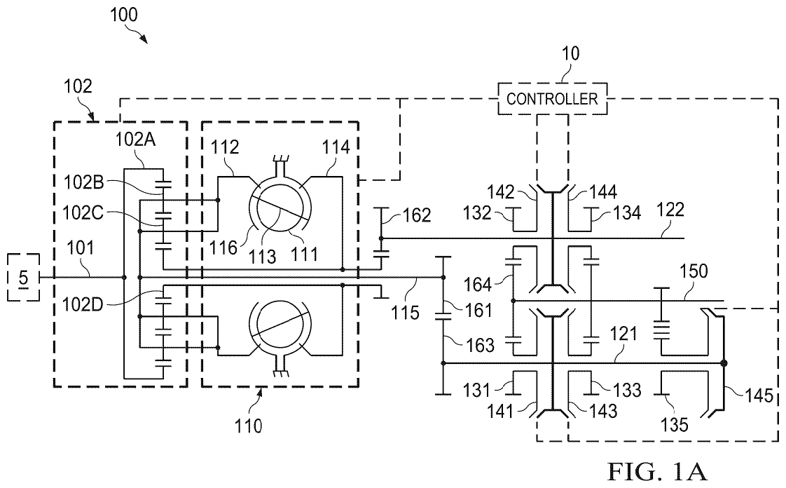

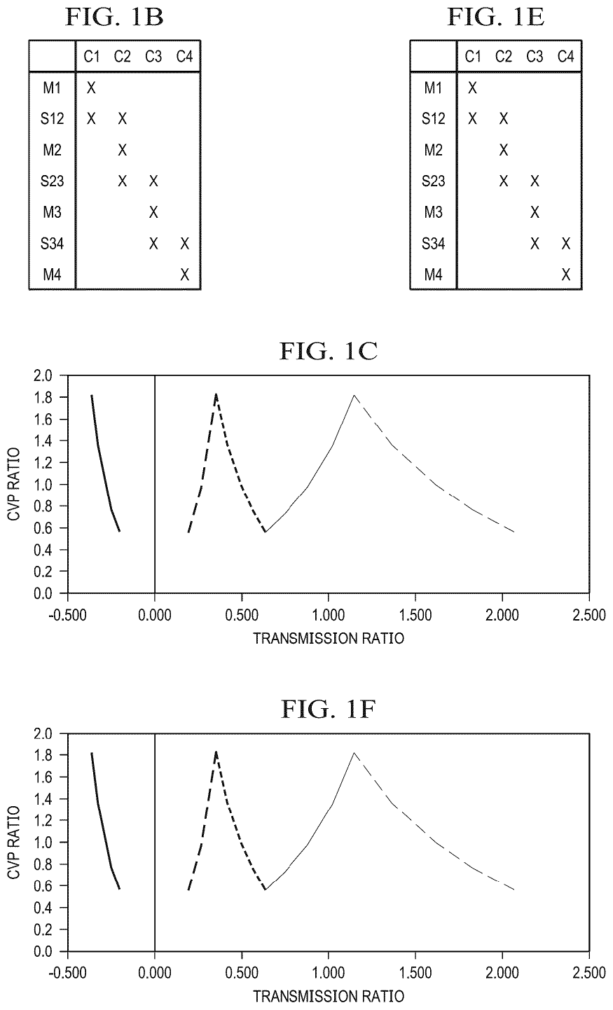

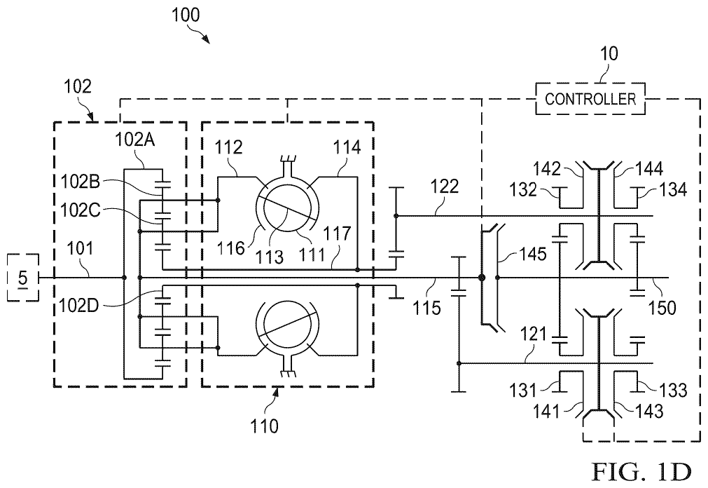

A drivetrain with a ball-planetary continuously variable transmission allows for continuous speed ratios over a range of transmission ratios. In an embodiment depicted in FIG. 1A, transmission 100 includes input shaft 101 for receiving power from prime mover 5, planetary gear set 102, CVT 110, first countershaft 121 associated with first gear 131 and third gear 133 and second countershaft 122 associated with second gear 132 and fourth gear 134, and output shaft 150 configured to receive power from either first countershaft 121 or second countershaft 122. For example, one embodiment may have the following gear ratios. First gear 131 and second gear 132 may be −0.0504:1, reverse gear 135, may be 0.504:1, third gear 133 and fourth gear may be −1.632:1, while input gearing to the first countershaft 121 may be −0.556:1, and input planetary gear 102 may have a sun to ring ratio of 0.5.

In an alternative embodiment depicted in FIG. 1D, transmission 100 includes input shaft 101 for receiving power from prime mover 5, planetary gear set 102, CVT 110, first countershaft 121 associated with first gear 131 and third gear 133 and second countershaft 122 associated with second gear 132 and fourth gear 134, and output shaft 150 configured to receive power from either first countershaft 121 or second countershaft 122.

Planetary gearset 102 is configured for receiving power from input shaft 101 and splitting the power between two power paths. In some embodiments, planetary gearset 102 is a double planetary gearset having ring gear 102A, first planetary gears 102B, second planetary gears 102C and sun gear 102D. Planetary gearset 102 may be configured with first planetary gears 102B coupled to CVT 110 such that a portion of the power received from input shaft 101 is transferred along a first power path to CVT 110 to thru shaft 117 and back through sun gear 102D to second planetary gears 102C, and further configured with second planetary gears 102C coupled to thru shaft 115 such that a portion of power received from input shaft 101 is transferred along a second power path to thru shaft 115 without transferring through CVT 110. CVT 110 is capable of modulating power between a first maximum speed ratio and a second maximum speed ratio.

In some embodiments, CVT 110 is a ball-planetary continuously variable transmission (CVP) comprising a plurality of traction planets 111 interposed between first traction ring 112 and second traction ring 114 and located radially outward of a traction sun (not shown). In some embodiments, an input power may be received by first traction ring 112 and transferred across traction planets 111 to second traction ring 114 or the traction sun. A speed ratio of CVT 110 may be determined by tilting the plurality of traction planets 111, such as by tilting axles 113 attached to planets 111. Axles 113 may be tilted to any angle between a first angle associated with the first maximum value and a second angle associated with the second maximum value. The first maximum value and the second maximum value depend on the direction power is transferred through CVT 110. Thus, if power is transferred from first traction ring 112 through traction planets 111 to second traction ring 114, the first angle may be associated with full underdrive and the second angle may be associated with full overdrive, whereas if power is transferred from second traction ring 114 through traction planets 111 to first traction ring 112, the first angle may be associated with full overdrive and the second angle may be associated with full underdrive.

Power transferred along the first power path may combine with power transferred along the second power path. In some embodiments. Power from the first power path and the second power path may combine at planetary gearset 102. In some embodiments, planetary gearset 102 is a double planetary gearset. The combined power may be transferred along thru shaft 115 to one of first countershaft 121 or second countershaft 122.

In a first mode or a third mode, power is transferred to first countershaft 121. In the first mode, first countershaft 121 may be coupled to first gear 131 by engaging first clutch 141 and in the third mode, countershaft 121 may be coupled to third gear 133 by engaging third clutch 143.

In a second mode or a fourth mode, power is transferred to second countershaft 122. In the second mode, second countershaft 122 may be coupled to second gear 132 by engaging second clutch 142 and in the fourth mode, countershaft 122 may be coupled to fourth gear 134 by engaging fourth clutch 144.

In a reverse mode, power is transferred to shaft 150 by engaging reverse clutch 145.

Output shaft 150 may be coupled to first countershaft 121 and second countershaft 122 such that power transferred through transmission 100 in the first mode, the third mode, or the second mode, or fourth mode (respectively), or the reverse mode is transferred to output shaft 150 for transmitting to other systems or components downstream.

A control system for transmission 100 comprises controller 10 communicatively coupled to each of first clutch 141, second clutch 142, third clutch 143 and fourth clutch 144 and reverse clutch 145. Controller 10 may be communicatively coupled to variator 110 for controlling the speed ratio of variator 110 and may be communicatively coupled to planetary gearset 102 for controlling a power path through planetary gearset 102, including controlling splitting power and controlling a direction power is transferred through variator 110.

In operation, controller 10 receives signals from sensors associated with transmission 100 and inputs from prime mover 5, a user or the environment, analyzes the received signals, and determines one of a configuration and a control algorithm for transmission 100. Controller 10 sends commands to clutches 141, 142, 143, 144, 145 to configure transmission 100 according to a first mode, a second mode, a third mode, a fourth mode, or a reverse mode. Controller 10 may also implement or determine a control algorithm for transmission 100. A control algorithm may determine when to engage and disengage clutches 141, 142, 143, 144, 145 based on engine RPM or some other condition such as prime mover speed, prime mover rate of change, power generated, power generation rate, vehicle speed, vehicle acceleration, power transferred to an accessory drive or auxiliary drive, an efficiency map or power map, or some other parameter, characteristic or data structure stored in memory (not shown but common in the field for transmission controllers).

In some embodiments, controller 10 receives an input corresponding to a transmission ratio and a power generated by prime mover 5, determines an algorithm for achieving the transmission ratio, and determines which of gears 131, 132, 133, 134 and 135 and what variator range achieves the transmission ratio. For example, one embodiment may have the following gear ratios. First gear 131 and second gear 132 may be −0.0504:1, reverse gear 135, may be 0.504:1, third gear 133 and fourth gear may be −1.632:1, while input gearing to the first countershaft 121 may be −0.556:1, and input planetary gear 102 may have a sun to ring ratio of 0.5.

FIG. 1B depicts a table of clutch states corresponding to four forward modes and a reverse mode. As depicted in FIG. 1B, a first mode corresponds to first clutch 141 engaging first gear 131, a second mode corresponds to second clutch engaging second gear 132, a third mode corresponds to third clutch 143 engaging third gear 133 and a fourth mode corresponds to fourth clutch 144 engaging fourth gear 134. A reverse mode corresponds to reverse clutch 145 engaging reverse gear 135.

Switching from first mode to second mode comprises second clutch 142 engaging second gear 132 and disengaging first clutch 141 from first gear 131. Switching from second mode to third mode comprises third clutch 143 engaging third gear 133 and disengaging second clutch 142 from second gear 132. Switching from third mode to fourth mode comprises fourth clutch 144 engaging fourth gear 134 and disengaging third clutch 143 from third gear 133. Switching from any mode to reverse mode comprises disengaging any of clutches 141, 142, 143, 144 from gear 131, 132, 133, or 134 and engaging reverse clutch 145 to reverse gear 135. As should be apparent in FIG. 1B, C1 is first clutch 141, C2 is second clutch 142, C3 is third clutch 143, and C4 is fourth clutch 144.

FIG. 1C depicts a graph of transmission ratio relative to speed ratio for a constant power input, illustrating how transmission 100 is controlled using the synchronous shifting strategy depicted in FIG. 1B to achieve a continuous range of transmission ratios using a CVT.

FIG. 1E depicts a table of clutch states corresponding to four forward modes and a reverse mode. As depicted in FIG. 1E, a first mode corresponds to first clutch 141 engaging first gear 131, a second mode corresponds to second clutch engaging second gear 132, a third mode corresponds to third clutch 143 engaging third gear 133 and a fourth mode corresponds to fourth clutch 144 engaging fourth gear 134. A reverse mode corresponds to reverse clutch 145 engaging reverse gear 135.

FIG. 1F depicts a graph of transmission ratio relative to speed ratio for a constant power input, illustrating how transmission 100 controlled using the synchronous shifting strategy depicted in FIG. 1E to achieve a continuous range of transmission ratios using a CVT 110.

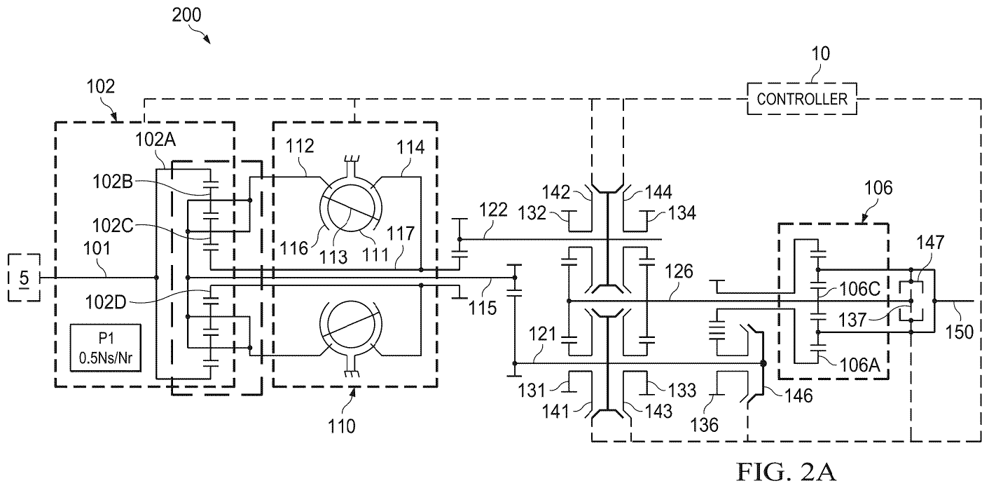

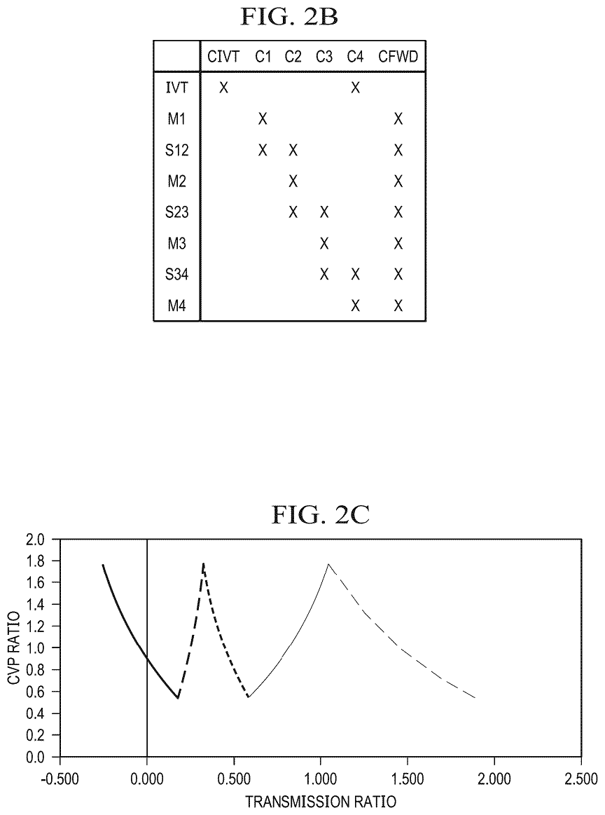

In an embodiment depicted in FIG. 2A, transmission 200 is coupled to prime mover 5. Power from prime mover 5 enters transmission 200 and flows through input shaft 101, planetary gear set 102, CVT 110, first countershaft 121 associated with first gear 131, third gear 133 and infinitely variable transmission (IVT) gear 136 and second countershaft 122 associated with second gear 132 and fourth gear 134, and is transmitted via intermediary shaft 126 configured to receive power from either first countershaft 121 or second countershaft 122 to second planetary gearset 106 for exiting via output shaft 150.

Planetary gearset 102 is configured for receiving power from input shaft 101 and splitting the power between two power paths. In some embodiments, planetary gearset 102 is a double planetary gearset having ring gear 102A, first planetary gears 102B, second planetary gears 102C and sun gear 102D. Planetary gearset 102 may be configured with first planetary gears 102B coupled to CVT 110 such that a portion of the power received from input shaft 101 is transferred along a first power path to CVT 110 to thru shaft 115 and back through sun gear 102D to second planetary gears 102C, and further configured with second planetary gears 102C coupled to thru shaft 115 such that a portion of power received from input shaft 101 is transferred along a second power path to thru shaft 115 without transferring through CVT 110. CVT 110 is capable of modulating power between a first maximum speed ratio and a second maximum speed ratio.

In some embodiments, CVT 110 is a ball-planetary continuously variable transmission (CVP) comprising a plurality of traction planets 111 interposed between first traction ring 112 and second traction ring 114 and located radially outward of a traction sun (not shown). In some embodiments, an input power may be received by first traction ring 112 and transferred across traction planets 111 to second traction ring 114 or the traction sun. A speed ratio of CVT 110 may be determined by tilting the plurality of traction planets 111, such as by tilting axles 113 attached to planets 111. Axles 113 may be tilted to any angle between a first angle associated with the first maximum value and a second angle associated with the second maximum value. The first maximum value and the second maximum value depend on the direction power is transferred through CVT 110. Thus, if power is transferred from first traction ring 112 through traction planets 111 to second traction ring 114, the first angle may be associated with full underdrive and the second angle may be associated with full overdrive, whereas if power is transferred from second traction ring 114 through traction planets 111 to first traction ring 112, the first angle may be associated with full overdrive and the second angle may be associated with full underdrive.

Power transferred along the first power path may combine with power transferred along the second power path. In some embodiments. Power from the first power path and the second power path may combine at planetary gearset 102. In some embodiments, planetary gearset 102 is a double planetary gearset. In certain embodiments for any of the transmissions discussed throughout this application, planetary gearset 102 includes clutches or other connections common to those of skill in the art to fix or release the carriers of first planetary gears 102B, second planetary gears 102C, or other components of the planetary gearset 102 as needed to allow power to be routed through various pathways through the planetary gearset 102 depending on the desired mode. The inclusion of such clutches or other connection types is readily apparent to those of skill in the art, but are not illustrated here in order not to complicate the drawing and because they are typical in the industry for such gearsets. The combined power may be transferred along thru shaft 115 to one of first countershaft 121 or second countershaft 122.

In a first mode, third mode or IVT mode, power is transferred to first countershaft 121. In the first mode, first countershaft 121 may be coupled to first gear 131 by engaging first clutch 141. In the third mode, countershaft 121 may be coupled to third gear 133 by engaging third clutch 143.

In a second mode or a fourth mode, power is transferred to second countershaft 122. In the second mode, second countershaft 122 may be coupled to second gear 132 by engaging second clutch 142 and in the fourth mode, countershaft 122 may be coupled to fourth gear 134 by engaging fourth clutch 144.

In an infinitely variable transmission (IVT) configuration, first countershaft 121 may be coupled to IVT gear 136 by engaging IVT clutch 146 and second countershaft 122 is coupled to fourth gear 134 by engaging fourth clutch 144. In an IVT mode, transmission 200 is capable of forward, reverse, and powered zero states. Power from fourth gear 134 may be transmitted along intermediary shaft 126 to output planetary gearset 106 and power from IVT gear 136 may be transmitted to output planetary gearset 106. In some embodiments, power from fourth gear 134 may be transmitted along intermediary shaft 126 to sun gear 106C of output planetary gearset 106 and power from IVT gear 136 may be transmitted to ring 106A of output planetary gearset 106. Power may exit second planetary gearset 106 to output shaft 150.

Intermediary shaft 126 may be coupled to first countershaft 121 and second countershaft 122 such that power transferred through transmission 200 in the first mode, the second mode, or the reverse mode is transferred to intermediary shaft 126 for transmitting to other systems or components downstream.

A control system for transmission 200 comprises controller 10 communicatively coupled to each of first clutch 141, second clutch 142, third clutch 143, fourth clutch 144, and IVT clutch 146. Controller 10 may be communicatively coupled to variator 110 for controlling the speed ratio of variator 110 and may be communicatively coupled to planetary gearset 102 for controlling a power path through planetary gearset 102, by use of clutches or other connections as described above, including controlling splitting power and controlling a direction power is transferred through variator 110.

In operation, controller 10 receives signals from sensors associated with transmission 200 and inputs from prime mover 5, a user or the environment, analyzes the received signals, and determines one of a configuration and a control algorithm for transmission 100. Controller 10 sends commands to clutches 141, 142, 143, 144, 146 to configure transmission 200 according to a first mode, a second mode, a third mode, a fourth mode, or an IVT mode. Controller 10 may also determine a control algorithm for transmission 200. A control algorithm may determine when to engage and disengage clutches 141, 142, 143, 144, 146 based on engine RPM or some other condition such as prime mover speed, prime mover rate of change, power generated, power generation rate, vehicle speed, vehicle acceleration, power transferred to an accessory drive or auxiliary drive, an efficiency map or power map, or some other parameter, characteristic or data structure stored in memory.

In some embodiments, controller 10 receives an input corresponding to a transmission ratio and a power generated by prime mover 5, determines an algorithm for achieving the transmission ratio, and determines which combination of gears 131, 132, 133, 134, 136 and 137 and what variator range achieves the transmission ratio.

FIG. 2B depicts a table of clutch states corresponding to four forward modes and an IVT mode. As depicted in FIG. 2B, a first mode corresponds to first clutch 141 engaging first gear 131 and forward clutch 147 engaging forward gear 137, a second mode corresponds to second clutch 142 engaging second gear 132 and forward clutch 147 engaging forward gear 137, a third mode corresponds to third clutch 143 engaging third gear 133 and forward clutch 147 engaging forward gear 137 and a fourth mode corresponds to fourth clutch 144 engaging fourth gear 134 and forward clutch 147 engaging forward gear 137. An IVT mode corresponds to IVT clutch 146 engaging IVT gear 136 and fourth clutch 144 engaging fourth gear 134. The IVT mode is capable of forward, reverse and powered neutral states.

Switching from first mode to second mode comprises second clutch 142 engaging second gear 132 and disengaging first clutch 141 from first gear 131. Switching from second mode to third mode comprises third clutch 143 engaging third gear 133 and disengaging second clutch 142 from second gear 132. Switching from third mode to fourth mode comprises fourth clutch 144 engaging fourth gear 134 and disengaging third clutch 143 from third gear 133. Switching from IVT mode to first mode comprises disengaging IVT clutch 146 from IVT gear 136, disengaging fourth clutch 144 from fourth gear 134, engaging first clutch 141 to gear 131, and engaging forward clutch 147 to forward gear 137. As should be apparent in FIG. 2B, CIVT is IVT clutch 146, Cl is first clutch 141, C2 is second clutch 142, C3 is third clutch 143, and C4 is fourth clutch 144.

FIG. 2C depicts a graph of transmission ratio relative to CVP speed ratio for a constant power input, illustrating how transmission 200 using a CVT and controlled using the synchronous shifting strategy depicted in FIG. 2B may achieve a continuous range of transmission ratios including forward travel, reverse travel, and powered zero.

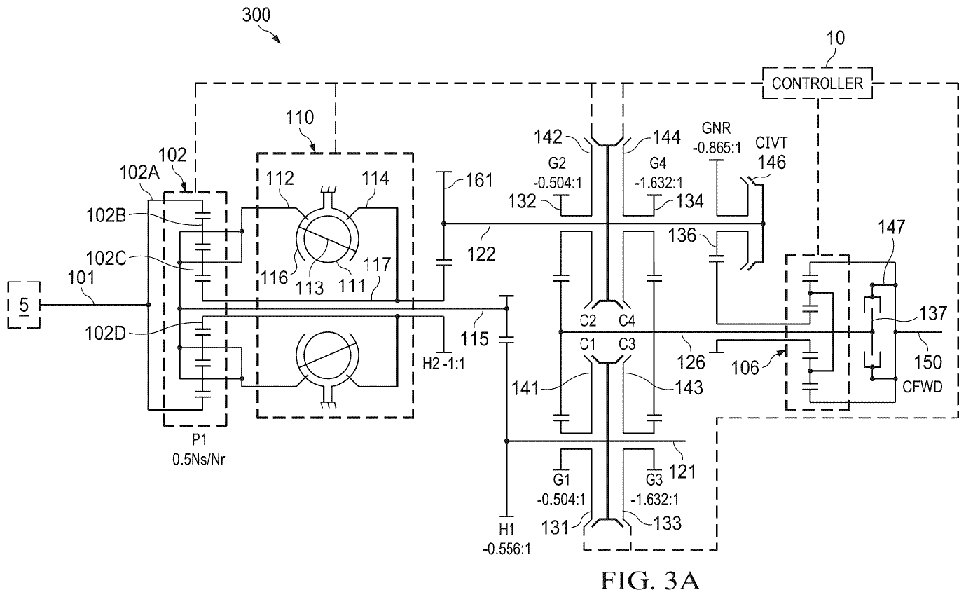

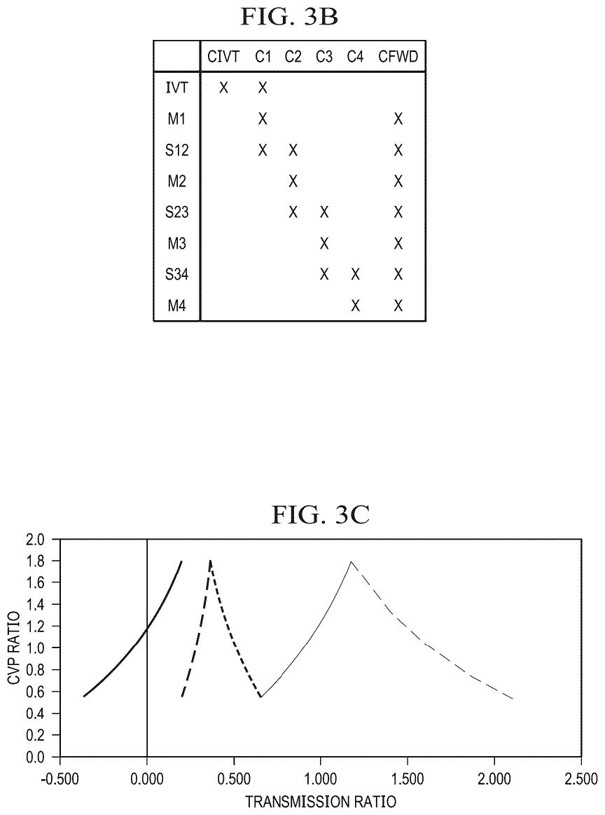

In an embodiment depicted in FIG. 3A, transmission 300 is coupled to prime mover 5. Power from prime mover 5 enters transmission 300 and flows through input shaft 101, planetary gear set 102, CVT 110, first countershaft 121 associated with first gear 131, and third gear 133 and second countershaft 122 associated with second gear 132, fourth gear 134, and infinitely variable transmission (IVT) gear 136, and is transmitted via intermediary shaft 126 configured to receive power from either first countershaft 121 or second countershaft 122 to second planetary gearset 106 for exiting via output shaft 150.

Planetary gearset 102 is configured for receiving power from input shaft 101 and splitting the power between two power paths. In some embodiments, planetary gearset 102 is a double planetary gearset having ring gear 102A, first planetary gears 102B, second planetary gears 102C and sun gear 102D, and clutches or connections to facilitate selection of desired power path (not shown) as discussed above. Planetary gearset 102 may be configured with first planetary gears 102B coupled to CVT 110 such that a portion of the power received from input shaft 101 is transferred along a first power path to CVT 110 to thru shaft 117 and back through sun gear 102D to second planetary gears 102C, and further configured with second planetary gears 102C coupled to thru shaft 115 such that a portion of power received from input shaft 101 is transferred along a second power path to thru shaft 115 without transferring through CVT 110. CVT 110 is capable of modulating power between a first maximum speed ratio and a second maximum speed ratio.

In some embodiments, CVT 110 is a ball-planetary continuously variable transmission (CVP) comprising a plurality of traction planets 111 interposed between first traction ring 112 and second traction ring 114 and located radially outward of a traction sun. In some embodiments, an input power may be received by first traction ring 112 and transferred across traction planets 111 to second traction ring 114 or the traction sun. A speed ratio of CVT 110 may be determined by tilting the plurality of traction planets 111, such as by tilting axles 113 attached to planets 111. Axles 113 may be tilted to any angle between a first angle associated with the first maximum value and a second angle associated with the second maximum value. The first maximum value and the second maximum value depend on the direction power is transferred through CVT 110. Thus, if power is transferred from first traction ring 112 through traction planets 111 to second traction ring 114, the first angle may be associated with full underdrive and the second angle may be associated with full overdrive, whereas if power is transferred from second traction ring 114 through traction planets 111 to first traction ring 112, the first angle may be associated with full overdrive and the second angle may be associated with full underdrive.

Power transferred along the first power path may combine with power transferred along the second power path. In some embodiments. Power from the first power path and the second power path may combine at planetary gearset 102. In some embodiments, planetary gearset 102 is a double planetary gearset. The combined power may be transferred along thru shaft 115 to one of first countershaft 121 or second countershaft 122.

In a first mode or third mode, power is transferred to first countershaft 121. In the first mode, first countershaft 121 may be coupled to first gear 131 by engaging first clutch 141. In the third mode, countershaft 121 may be coupled to third gear 133 by engaging third clutch 143.

In a second mode, a fourth mode or an IVT mode, power is transferred to second countershaft 122. In the second mode, second countershaft 122 may be coupled to second gear 132 by engaging second clutch 142. In the fourth mode, countershaft 122 may be coupled to fourth gear 134 by engaging fourth clutch 144.

In an IVT mode, second countershaft 122 may be coupled to IVT gear 136 by engaging IVT clutch 146 and first countershaft 121 is coupled to first gear 131 by engaging first clutch 141. In an IVT mode, transmission 300 is capable of forward, reverse, and powered zero states. Power from first gear 131 may be transmitted along intermediary shaft 126 to output planetary gearset 106 and power from IVT gear 136 may be transmitted to output planetary gearset 106. In some embodiments, power from first gear 131 may be transmitted along intermediary shaft 126 to sun gear 106C of output planetary gearset 106 and power from IVT gear 136 may be transmitted to sun 106D of output planetary gearset 106. Power may exit second planetary gearset 106 to output shaft 150. Exemplary gear ratios are provided in FIG. 3A, but are only meant as examples and not in any limiting manner, and those of skill in the art will appreciate that other gear ratios can be provided depending on the duty cycle of the system with design configurations being resolved through standard methodologies.

Intermediary shaft 126 may be coupled to first countershaft 121 and second countershaft 122 such that power transferred through transmission 300 in the first mode, the second mode, the third mode, the fourth mode, or the reverse mode is transferred to intermediary shaft 126 for transmitting to other systems or components downstream.

A control system for transmission 300 comprises controller 10 communicatively coupled to each of first clutch 141, second clutch 142, third clutch 143, fourth clutch 144, and IVT clutch 146. Controller 10 may be communicatively coupled to variator 110 for controlling the speed ratio of variator 110 and may be communicatively coupled to planetary gearset 102 for controlling a power path through planetary gearset 102, including controlling splitting power and controlling a direction power is transferred through variator 110.

In operation, controller 10 receives signals from sensors associated with transmission 300 and inputs from prime mover 5, a user or the environment, analyzes the received signals, and determines one of a configuration and a control algorithm for transmission 100. Controller 10 sends commands to clutches 141, 142, 143, 144, 146 to configure transmission 300 according to a first mode, a second mode, a third mode, a fourth mode, or an IVT mode. Controller 10 may also determine a control algorithm for transmission 300. A control algorithm may determine when to engage and disengage clutches 141, 142, 143, 144, 146 based on engine RPM or some other condition such as prime mover speed, prime mover rate of change, power generated, power generation rate, vehicle speed, vehicle acceleration, power transferred to an accessory drive or auxiliary drive, an efficiency map or power map, or some other parameter, characteristic or data structure stored in memory.

In some embodiments, controller 10 receives an input corresponding to a transmission ratio and a power generated by prime mover 5, determines an algorithm for achieving the transmission ratio, and determines which combination of gears 131, 132, 133, 134, 136, and 137 and what variator range achieves the transmission ratio.

FIG. 3B depicts a table of clutch states corresponding to four forward modes and an IVT mode. As depicted in FIG. 3B, a first mode corresponds to first clutch 141 engaging first gear 131 and forward clutch 147 engaging forward gear 137, a second mode corresponds to second clutch 142 engaging second gear 132 and forward clutch 147 engaging forward gear 137, a third mode corresponds to third clutch 143 engaging third gear 133 and forward clutch 147 engaging forward gear 137 and a fourth mode corresponds to fourth clutch 144 engaging fourth gear 134 and forward clutch 147 engaging forward gear 137. An IVT mode corresponds to IVT clutch 146 engaging IVT gear 136 and first clutch 141 engaging first gear 131. The IVT mode is capable of forward, reverse and powered neutral states.

Switching from first mode to second mode comprises second clutch 142 engaging second gear 132 and disengaging first clutch 141 from first gear 131. Switching from second mode to third mode comprises third clutch 143 engaging third gear 133 and disengaging second clutch 142 from second gear 132. Switching from third mode to fourth mode comprises fourth clutch 144 engaging fourth gear 134 and disengaging third clutch 143 from third gear 133. Switching from IVT mode to first mode comprises disengaging IVT clutch 146 from IVT gear 136. As should be apparent in FIG. 3B, CIVT is IVT clutch 146, Cl is first clutch 141, C2 is second clutch 142, C3 is third clutch 143, C4 is fourth clutch 144, and CFWD is forward clutch 147.

FIG. 3C depicts a graph of transmission ratio relative to speed ratio for a constant power input, illustrating how transmission 300 using a CVT and controlled using the synchronous shifting strategy depicted in FIG. 3B may achieve a continuous range of transmission ratios including forward travel, reverse travel, and powered zero.

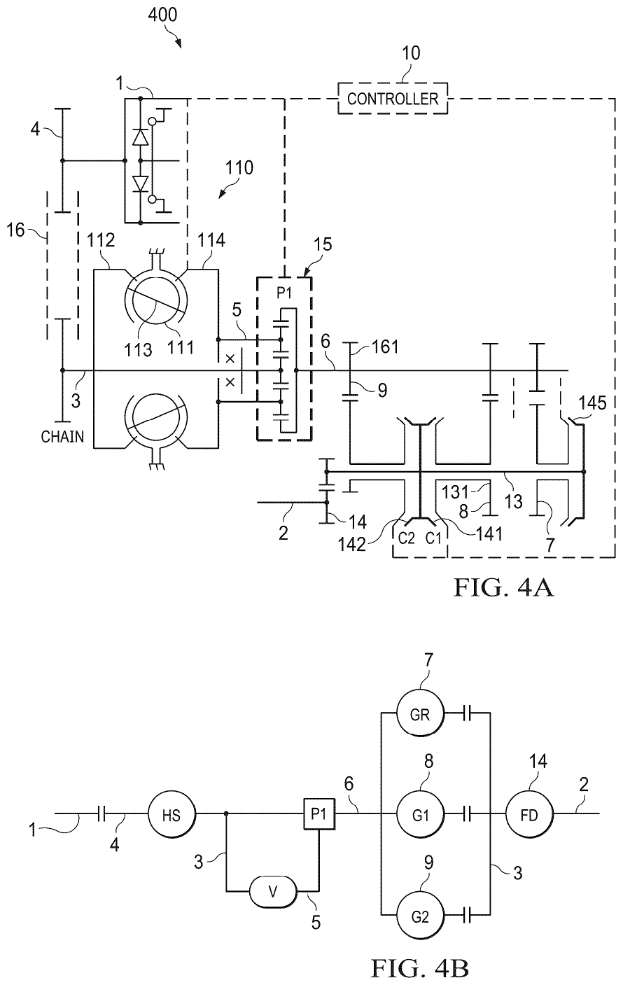

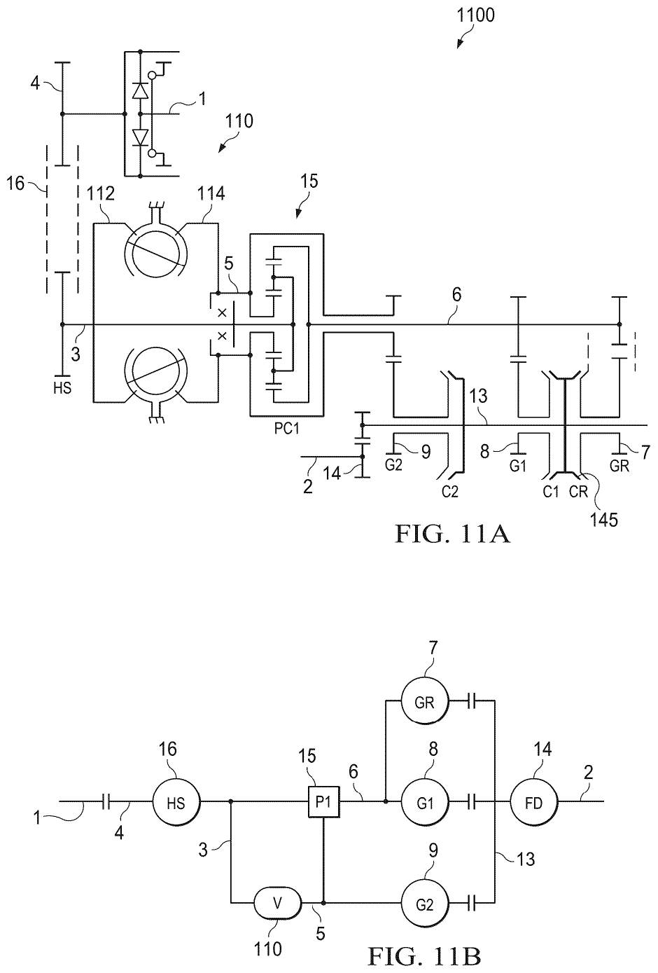

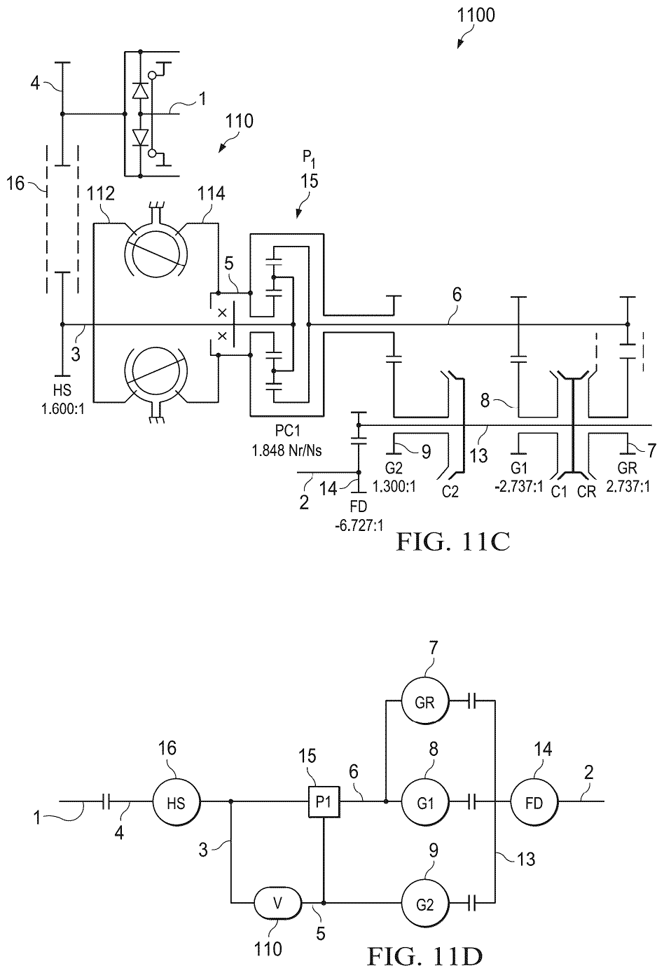

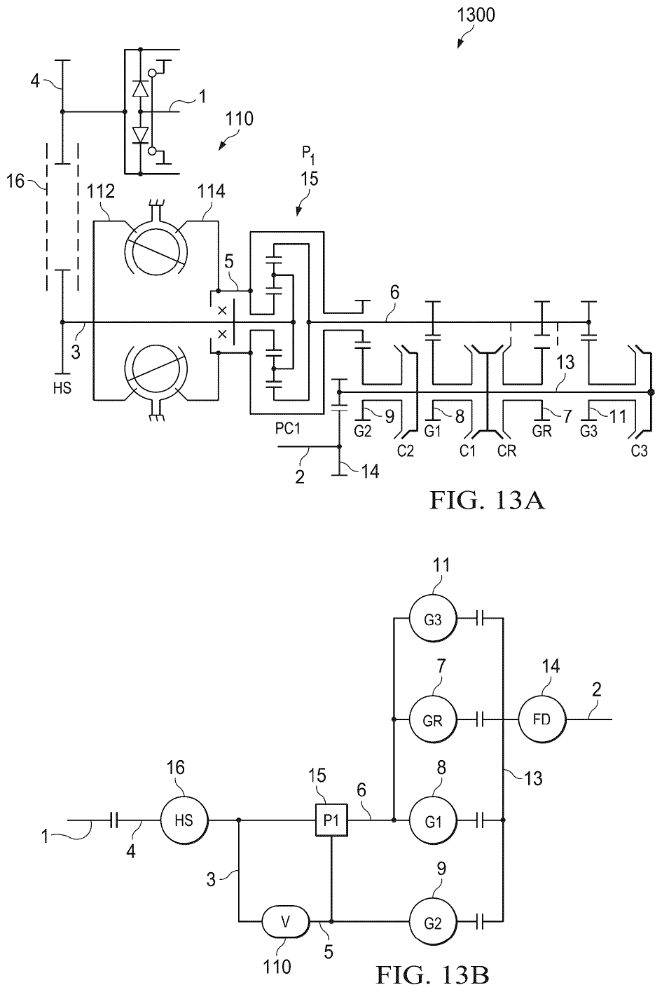

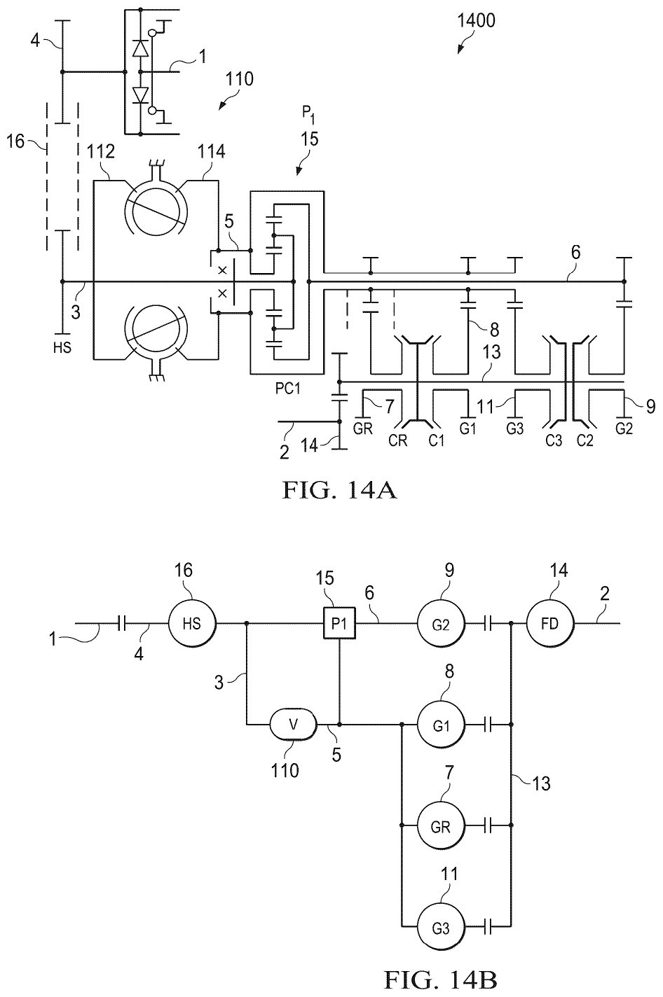

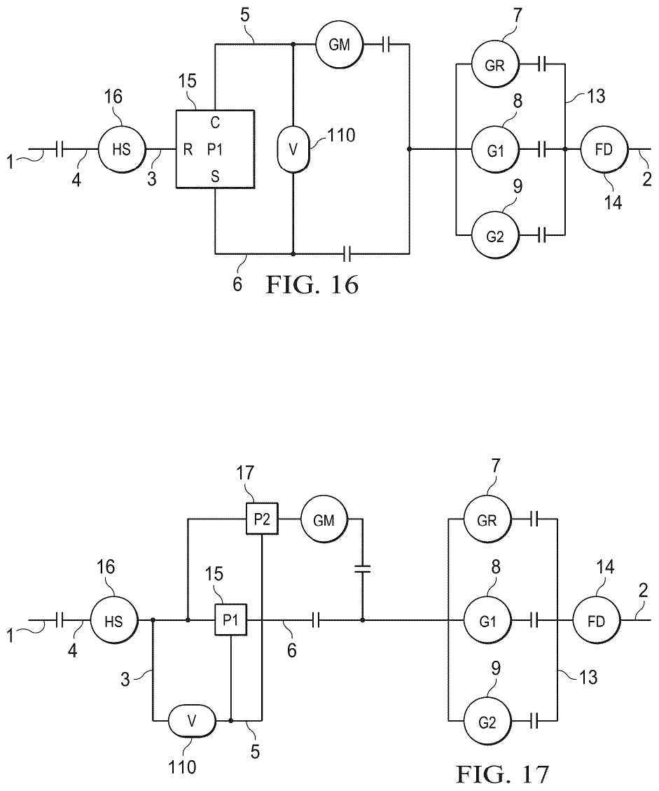

FIGS. 4A-4B, 5A-5B, 6A-6B, 7A-7B, 8A-8B, 9A-9B, 10A-10B, 11A-11B, 12A-12B, 13A-13B, 14A-14B, 15A-15B, 15C-15D, 16, and 17 depict schematic and block diagrams of embodiments of a drivetrain configured for multiple forward modes and a reverse mode. Each drivetrain may receive power from a prime mover, such as by input shaft 1. A drive clutch (not shown) can in some embodiments be used to allow a user to disengage a transmission from the prime mover. Power transmitted across the drive clutch to gear 4 is then transmitted by a chain drive 16 (denoted as “HS”) to thru shaft 3. While a chain drive 16 is described in this embodiment, other embodiments may utilize any other mechanical transmitting element such as, for example, a shaft or gears.

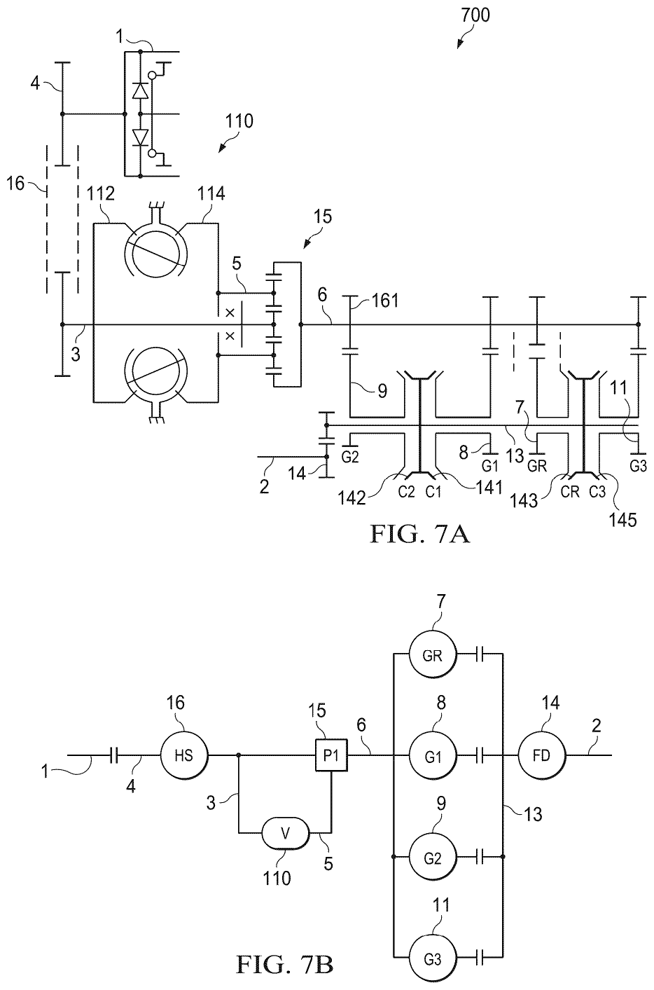

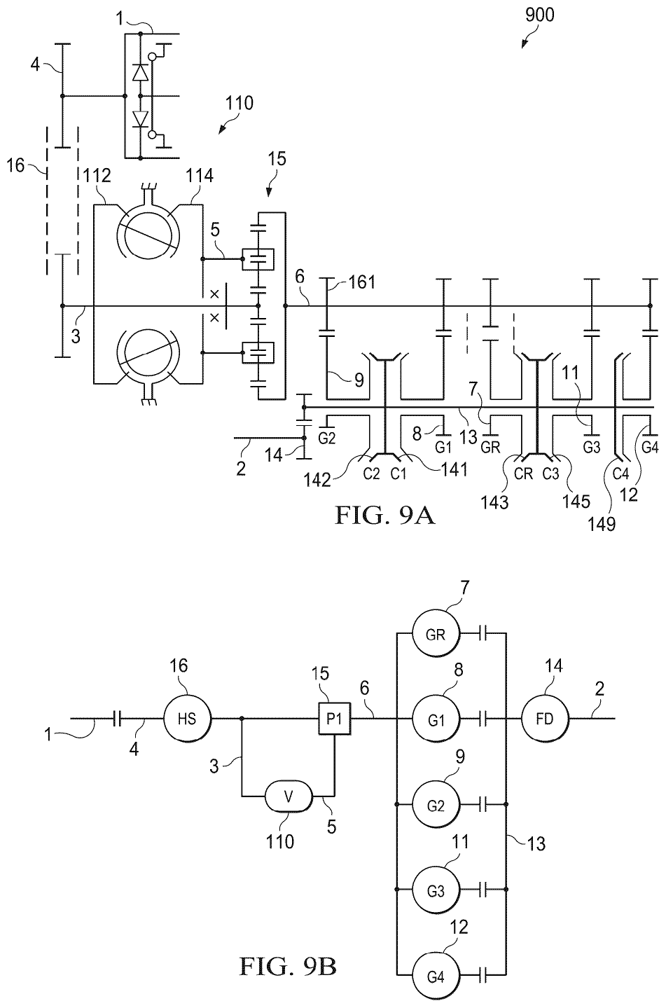

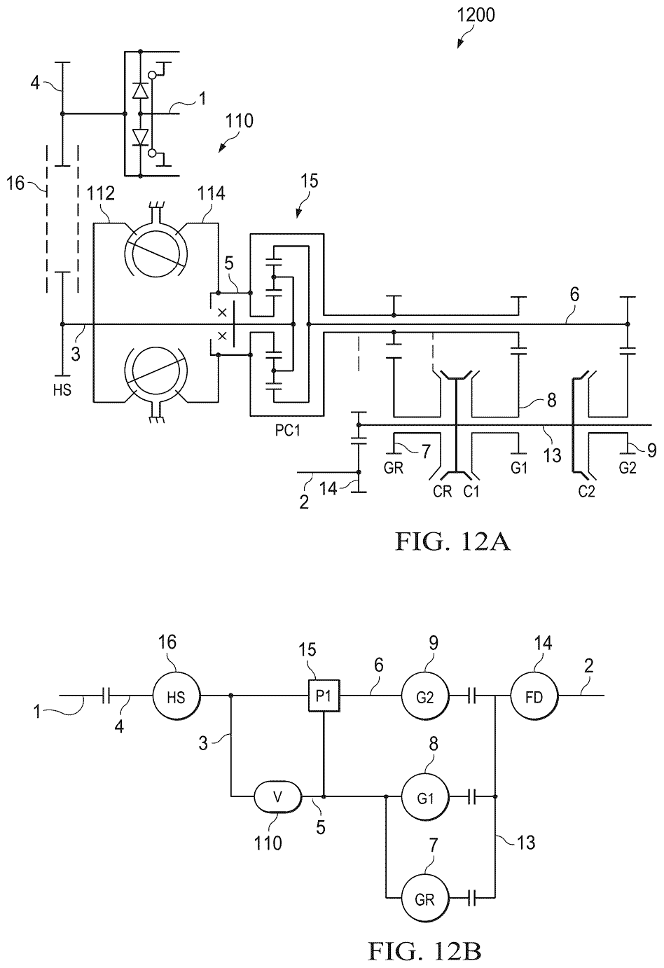

In some embodiments, such as depicted in FIGS. 4A-4B, 7A-7B, 9A-9B, 11A-11B, 12A-12B, 13A-13B, 14A-14B thru shaft 3 is coupled to a variator 110. Power exiting the variator 110 enters planetary gears set 15 and exits the planetary gearset 15 to a gearbox having a reverse clutch 145 for engaging with a reverse gear 7, a first clutch 141 for engaging with a first gear 8 and a second clutch 142 for engaging with a second gear 9. FIGS. 7A-7B and 13A-13B and 14A-14B further depict a third clutch 143 for engaging with a third gear 11. FIGS. 9A-9B further depict a fourth clutch 149 for engaging with a fourth gear 12 and the planetary gear set 15 is a double planetary gear set. FIGS. 12A-12B, 13A-13B, 14A-14B depict embodiments in which power may bypass the variator in a first configuration but enter variator 110 in a second configuration. Power routed through any of the gears (7, 8, 9, 11, 12) is transmitted via a countershaft 13 to a final drive 14 and exits via output shaft 2.

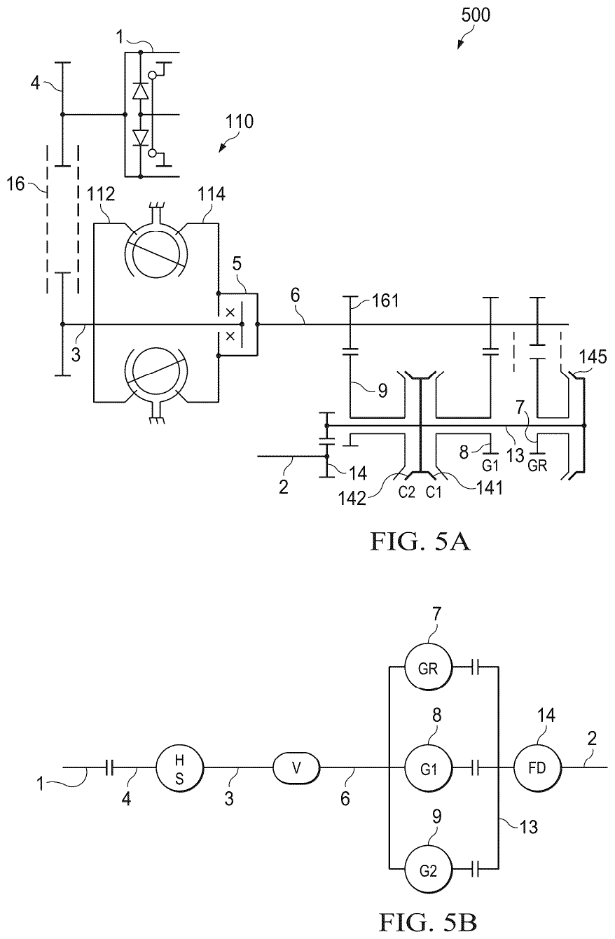

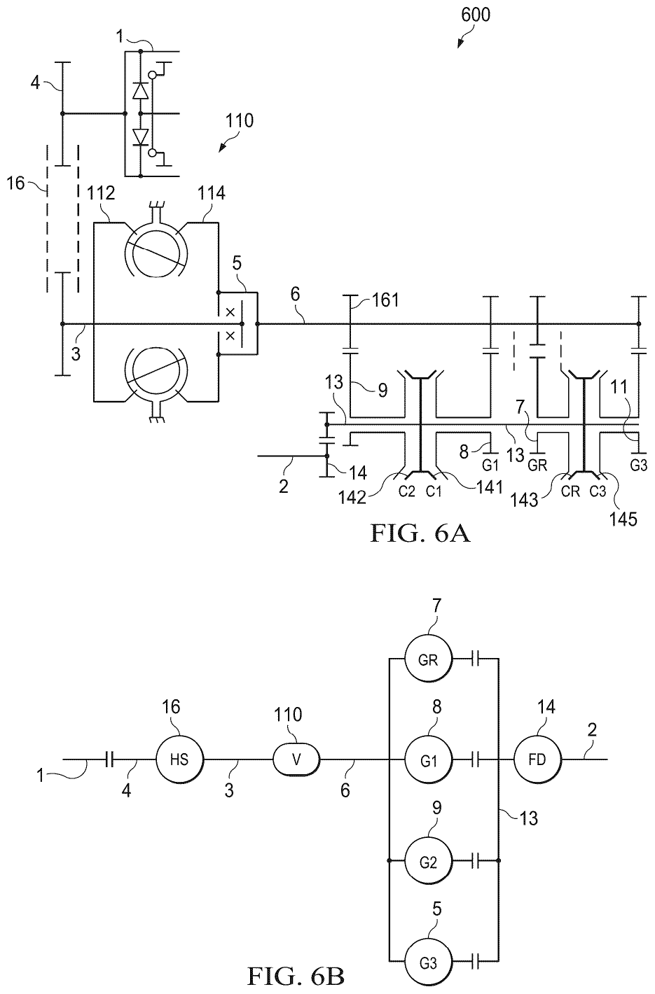

In some embodiments, such as depicted in FIGS. 5A-5B, 6A-6B, thru shaft 3 is coupled to a variator 11. Power exiting the variator 110 enters a gearbox having a reverse clutch 145 for engaging with a reverse gear 7, a first clutch 141 for engaging with a first gear 8 and a second clutch 142 for engaging with a second gear 9. FIGS. 6A-6B further depict a third clutch 143 for engaging with a third gear 5. Power routed through any of these gears (7, 8, 9, 5) is transmitted via a countershaft 13 to a final drive 14 and exits via output shaft 2.

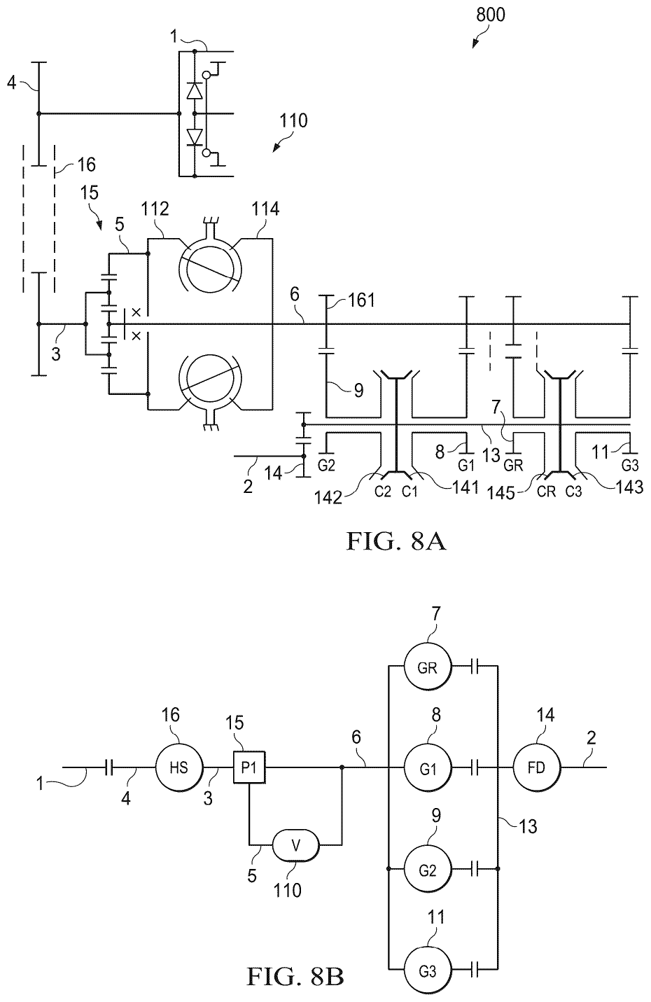

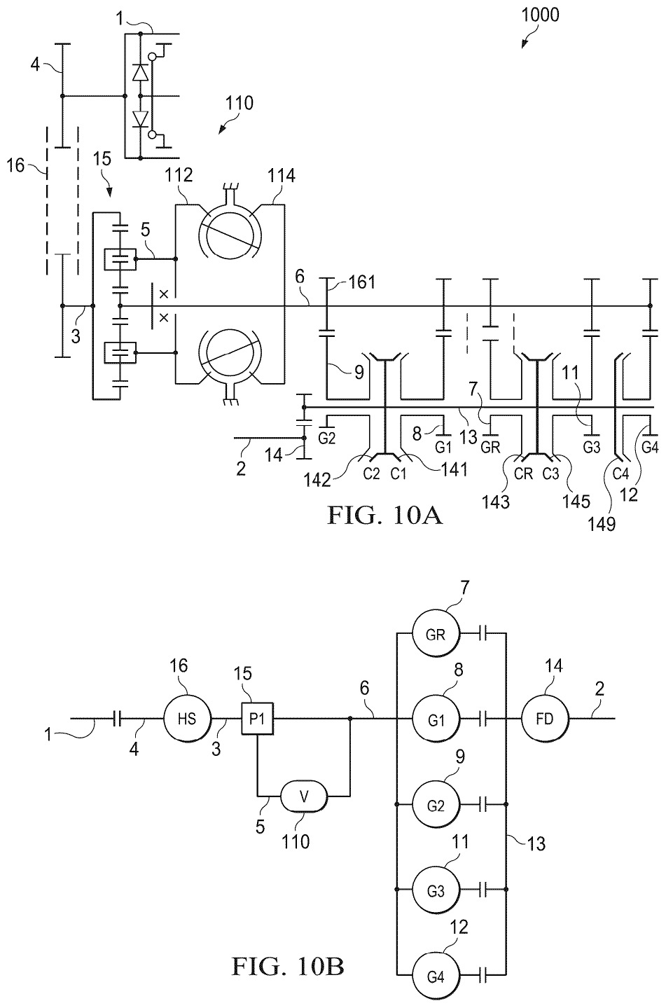

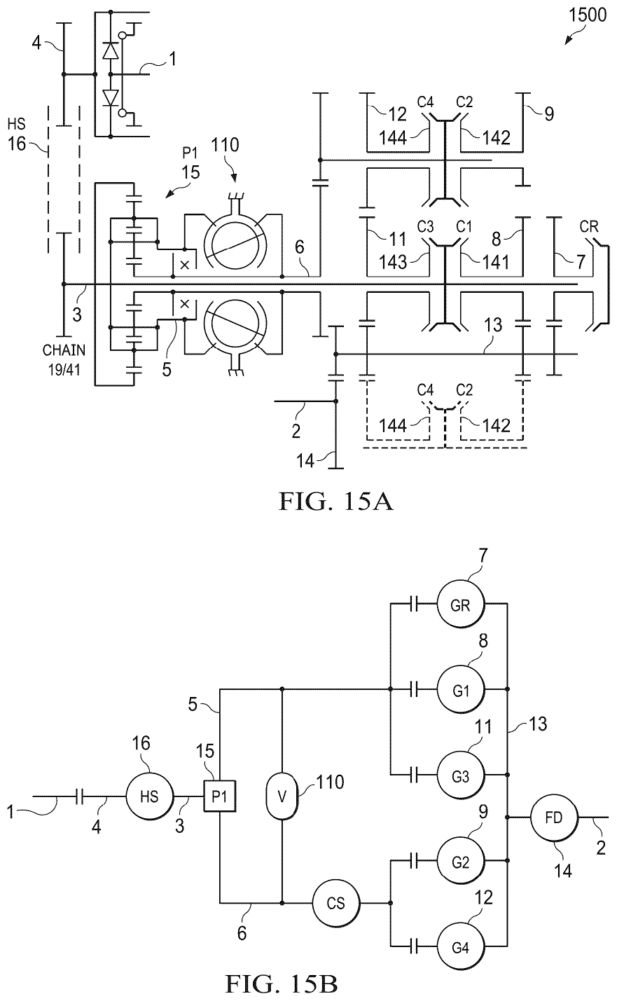

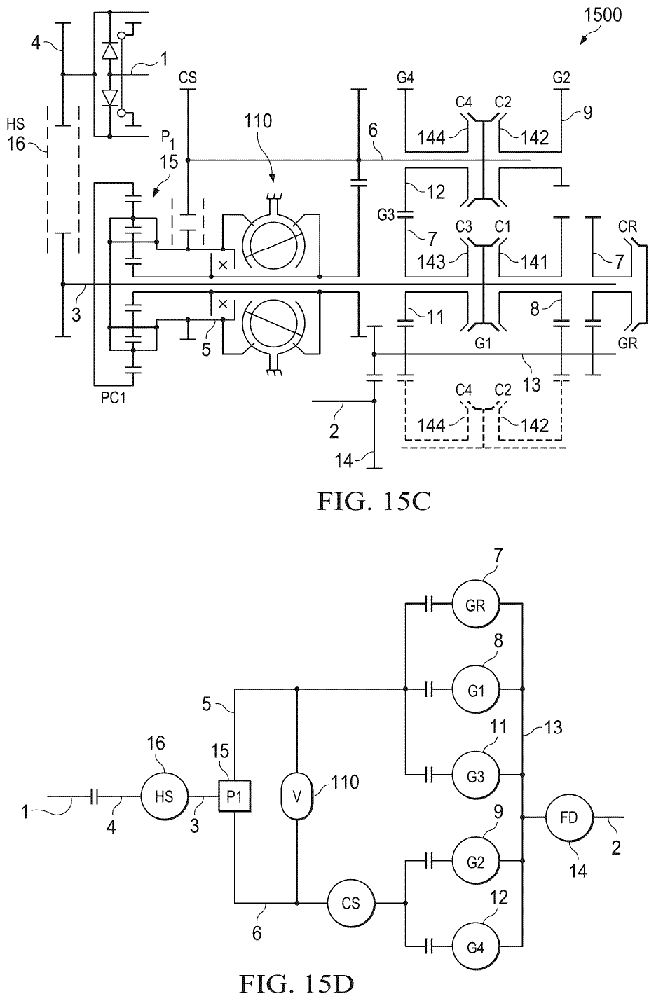

In some embodiments, such as depicted in FIGS. 8A-8B, 10A-10B, 15A-15B, 15C-15D, 16 thru shaft 3 is coupled to planetary gear set 15 which is coupled to variator 110. Power exiting variator 110 enters a gearbox having a reverse clutch 145 for engaging with a reverse gear 7, a first clutch 141 for engaging with a first gear 8, a second clutch 142 for engaging with a second gear 9 and a third clutch 143 for engaging with a third gear 11. FIGS. 10A-10B, 15A-15B further depict a third clutch 143 for engaging with a third gear 11, a fourth clutch 144 for engaging with a fourth gear 12 and the planetary gear set 15 is a double planetary gear set. Power routed through any of these gears is transmitted via a countershaft 10 to a final drive (FD) and exits via output shaft 2.

FIG. 17 depicts a second planetary gear set 17 for transmitting power from the variator to the gearbox.

The foregoing description details certain embodiments of the present disclosure. It will be appreciated. however, that no matter how detailed the foregoing appears in text. the present disclosure can be practiced in many ways.

1. (canceled)

2. A transmission, comprising:
a planetary gearset for receiving rotary power from one or more input sources, the planetary gearset including a first set of planetary gears and a second set of planetary gears;
a variator coupled to the planetary gearset and configured for stepless adjustment of a speed ratio over a range of speed ratios between a first maximum speed ratio and a second maximum speed ratio, the variator configured to receive the rotary power from the double planetary gearset and generate output variator power based on the rotary power and on the speed ratio;
a first countershaft associated with a first gear;
a second countershaft associated with a second gear, each of the first countershaft and the second countershaft configured to receive the output variator power and generate output gear power;
an output shaft configured to receive the output gear power from the first countershaft or the second countershaft; and
a control system, the control system comprising:
a first clutch corresponding to the first gear;
a second clutch corresponding to the second gear; and
a controller configured to adjust the speed ratio of the variator and selectively engage the first gear or the second gear, the controller configured to operate in a first mode at a first time and in a second mode at a second time,
wherein when in the first mode the controller is configured to cause the rotary power to transmit from the first set of planetary gears of
the double planetary gearset to the variator, engage the first gear of the first countershaft, and
adjust the variator from the first maximum speed ratio to the second maximum speed ratio to increase the transmission ratio from a first transmission ratio to a second transmission ratio, and
wherein when in the second mode the controller is configured to
cause the rotary power to transmit from the second set of planetary gears of the double planetary gearset to the variator,
engage the second gear of the second countershaft, and
adjust the variator from the second maximum speed ratio to the first maximum speed ratio to increase the transmission ratio from the second transmission ratio to a third transmission ratio, and
wherein when changing from the first mode to the second mode the controller is configured to
disengage the first clutch from the first gear,
engage the second clutch to the second gear, and
change from the first set of planetary gears to the second set of planetary gears.

3. The transmission of claim 2, wherein when changing from the first mode to the second mode the controller is further configured to change a configuration of the variator.

4. The transmission of claim 2, wherein the variator comprises a ball planetary continuously variable transmission comprising a plurality of traction planets, and wherein the controller is configured to change a tilt angle of the plurality of traction planets to adjust the speed ratio of the variator.

5. The transmission of claim 4, wherein the variator comprises a first traction ring on a first side of the plurality of traction planets, a second traction ring on a second side of the plurality of traction planets, and a sun located radially inward of the plurality of traction planets.

6. The transmission of claim 5, wherein in the first mode the rotary power is transferred from the first traction ring through the plurality of traction planets to one of the second traction ring or the traction sun.

7. The transmission of claim 5, wherein in the second mode the rotary power is transferred from the second traction ring through the plurality of traction planets to the first traction ring.

8. The transmission of claim 2, wherein the one or more input sources comprises a prime mover, the control system comprises a prime mover controller and a plurality of sensors associated with the prime mover and the transmission, and wherein the control system is further configured to:
receive an input signal associated with a target output power; and
adjust one or more parameters of the prime mover and the transmission to achieve the target output power.

9. The transmission of claim 8, wherein the control system is further configured to operate according to one of a plurality of control algorithms.

10. The transmission of claim 9, wherein the plurality of control algorithms includes an efficiency control algorithm that controls the prime mover and the transmission to operate based on an efficiency map.

11. The transmission of claim 10, wherein operating the control system using the efficiency control algorithm comprises maintaining the prime mover within an operating range for input power efficiency.

12. The transmission of claim 9, wherein the plurality of control algorithms includes a power control algorithm that controls the prime mover and the transmission to operate based on a power map.

13. The transmission of claim 12, wherein operating the control system using the power control algorithm comprises adjusting the prime mover over a range of power inputs for the target output power.

14. A transmission, comprising:
a planetary gearset for receiving rotary power from one or more input sources;
a variator coupled to the planetary gearset and configured for stepless adjustment of a speed ratio over a range of speed ratios between a first maximum speed ratio and a second maximum speed ratio, the variator configured to receive the rotary power and generate variator power;
a first countershaft associated with a first gear and a third gear;
a second countershaft associated with a second gear and a fourth gear, each of the first countershaft and the second countershaft configured to receive the variator power from the variator and generate output gear power;
an output shaft configured to receive the output gear power from the first countershaft or the second countershaft;
a control system, the control system comprising:
a first clutch corresponding to the first gear;
a second clutch corresponding to the second gear;
a third clutch corresponding to the third gear;
a fourth clutch corresponding to the fourth gear;
a controller configured to adjust the speed ratio of the variator and selectively engage the first gear, the second gear, the third gear or the fourth gear, the controller configured to operate in a first mode at a first time, in a second mode at a second time, in a third mode at a third time, and in a fourth mode at a fourth time,
wherein when in the first mode the controller is configured to
engage the first gear on the first countershaft, and
adjust the variator from the first maximum speed ratio to the second maximum speed ratio to increase the transmission ratio from a first transmission ratio to a second transmission ratio,
wherein when in the second mode the controller is configured to
engage the second gear on the second countershaft, and
adjust the variator from the second maximum speed ratio to the first maximum speed ratio to increase the transmission ratio from the second transmission ratio to a third transmission ratio,
wherein when in the third mode the controller is configured to
engage the third gear on the first countershaft, and
adjust the variator from the first maximum speed ratio to the second maximum speed ratio to increase the transmission ratio from the third transmission ratio to a fourth transmission ratio,
wherein when in the fourth mode the controller is configured to
engage the fourth gear on the second countershaft, and
adjust the variator from the second maximum speed ratio to the first maximum speed ratio to increase the transmission ratio from the fourth transmission ratio to a fifth transmission ratio,
wherein when changing from the first mode to the second mode the controller is configured to
disengage the first clutch from the first gear, and
engage the second clutch to the second gear,
wherein when changing from the second mode to the third mode the controller is configured to
disengage the second clutch from the second gear, and
engage the third clutch to the third gear,
wherein when changing from the third mode to the fourth mode the controller is configured to
disengage the third clutch from the third gear, and
engage the fourth clutch to the fourth gear.

15. The transmission of claim 14, further comprising:
an infinitely variable transmission (IVT) clutch;
a IVT gear coupled to the first countershaft;
an output planetary gearset coupled to the output shaft; and
a forward clutch coupled to the output planetary gearset, wherein the control system is further configured to engage the forward clutch for the first mode or the second mode, wherein in an IVT mode the control system is further configured to engage the IVT clutch to the IVT gear and engage the fourth clutch to the fourth gear, and wherein the control system is further configured to adjust the speed ratio of the variator to one of a positive transmission ratio, a negative transmission ratio, and a powered zero transmission ratio.

16. A transmission, comprising:
a planetary gearset for receiving rotary power from one or more input sources;
a variator coupled to the planetary gearset and configured for stepless adjustment of a speed ratio over a range of speed ratios between a first maximum speed ratio and a second maximum speed ratio, the variator configured to receive the rotary power and generate variator power;
a first countershaft associated with a first gear;
a second countershaft associated with a second gear, each of the first countershaft and the second countershaft configured to receive the variator power from the variator and generate output gear power;
an infinitely variable transmission (IVT) gear coupled to the second countershaft;
an output shaft configured to receive the output gear power from the first countershaft or the second countershaft;
an output planetary gearset coupled to the output shaft;
a control system comprising:
a first clutch corresponding to the first gear;
a second clutch corresponding to the second gear;
an IVT clutch corresponding to the IVT gear;
a forward clutch coupled to the output planetary gearset; and
a controller configured to adjust the speed ratio of the variator and selectively engage the first gear, the second gear, the IVT gear and the forward clutch, the controller configured to operate in a first mode at a first time, in a second mode at a second time, and in an IVT mode at a third time,
wherein when in the first mode the controller is configured to
engage the first gear on the first countershaft,
engage the forward clutch, and
adjust the variator from the first maximum speed ratio to the second maximum speed ratio to increase the transmission ratio from a first transmission ratio to a second transmission ratio,
wherein when in the second mode the controller is configured to
engage the second gear on the second countershaft,
engage the forward clutch, and
adjust the variator from the second maximum speed ratio to the first maximum speed ratio to increase the transmission ratio from the second transmission ratio to a third transmission ratio,
wherein when in the IVT mode the controller is configured to
engage the IVT clutch to the IVT gear, and
engage the first clutch to the first gear,
wherein when changing from the first mode to the second mode the controller is configured to
disengage the first clutch from the first gear, and
engage the second clutch to the second gear,
wherein when changing from the IVT mode to the first mode the controller is configured to
disengage the IVT clutch from the IVT gear, and
engage the forward clutch,
wherein the control system is further configured to adjust the speed ratio of the variator to one of a positive transmission ratio, a negative transmission ratio, and a powered zero transmission ratio.
